(19) United States
(12) Patent Application Publication
(10) Pub. No.: US 2017/0012439 A1
(43) Pub. Date: Jan. 12, 2017

(54) Control System and Strategy for Generator Set

(71) Applicant: Caterpillar Inc., Peoria, IL (US)

(72) Inventors: Yanchai Zhang, Dunlap, IL (US); Vijay Janardhan, Dunlap, IL (US); Perry D. Converse, Lafayette, IN (US)

(73) Assignee: CATERPILLAR INC., Peoria, IL (US)

(21) Appl. No.: 14/792,159

(22) Filed: Jul. 6, 2015

(51) Int. Cl. H02J 4/00; G05B 19/042

(52) U.S. Cl. CPC H02J 4/00; G05B 19/042; G05B 2219/2639

(57) ABSTRACT

A plurality of generator sets, or gensets, each including an electrical generator operatively associated with a prime mover, are arranged in parallel to generate electrical power for an isolated electrical load. To account for fuel efficiency, emissions considerations or similar consideration associated with the prime movers, an asymmetric load sharing method may be used to regulate operation of the plurality of gensets. A control strategy is configured to allocated real power demands of the electrical load among the plurality of gensets in accordance with the asymmetric load sharing method. The control strategy may account for the reactive power portions of the electrical load in addition to the real power portions.

### TECHNICAL FIELD

This patent disclosure relates generally to a plurality of generator sets arranged together to generate electrical power for an electrical load and, more particularly, to a method and strategy for distributing the electrical load among the plurality of generator sets.

### BACKGROUND

One manner of generating electrical power in the form of alternating current to provide electrical power for an electrical load, especially when connection to a larger electrical power grid supported by utilities is not readily available (i.e. “off-grid”), is to utilize a generator set, or genset for short. A genset includes in combination a prime mover and an electrical generator or alternator. The prime mover may be a mechanical engine such as an internal combustion engine (e.g., a diesel compression ignition engine) or gas turbine in which a hydrocarbon-based fuel and air is combusted to release the chemical energy therein and to convert that energy into a mechanical or motive force. The motive force, in turn, is used to rotate a rotor relative to a stator of the generator so that a magnetic field produced by one component induces electrical current in the field windings associated with the other component. The generated electricity is used to power electrical equipment connected via an electrical network or circuit with the genset, i.e., the electrical load. Because electrical equipment is often rated to operate within specific electrical parameters, such as rated frequency and voltage, it is important that the electrical output of the genset be controlled to comply with the rated characteristics.

The genset is typically operated to produce sufficient power output, often measured in wattage or kilowatts, to meet the power demanded by the electrical load, which often fluctuates over time. Occasionally, however, the demand may be higher than can be supplied by a single genset. In such instances, a multiple gensets may be operated together in a parallel arrangement to jointly meet the power demand. It is therefore necessary to allocate the real power demand among the plurality of gensets, especially as the power demand changes or fluctuates. It is also necessary to operate or configure the gensets so that they deliver power output complying with the required rated characteristics of the electrical load. This may be complicated by the fact that different gensets in the plurality may have different output capacities or electrical ratings than other gensets in the plurality. This is further complicated by the fact that, in addition to meeting the power demanded by the electrical load, the reactive power due to reactive components or equipment that are physical parts of the load must be accounted for.

One technique for allocating the power demand among multiple gensets is to operate them synchronously based in proportion on their individual rated capacities for power output in a manner sometimes referred to a symmetric load sharing or symmetric loading. In symmetric loading, the real power demand from the electrical load is converted to a percentage or ratio of the total capacity of the combined gensets. Each genset is operated to output power according to its relative capacity in proportion to the total capacity of the combined gensets. Hence, the genset are all being operated at the same percentage of their individual, relative capacity, and theoretically should be subjected to the same level of stress and wear, even though some gensets may be producing a larger absolute output than other gensets. Another advantage of symmetric load sharing is that the reactive power or imaginary power components of the alternating current are also proportionally distributed and satisfactorily accounted for.

While symmetrical load sharing helps ensure that each genset of the plurality is operated within its electrical capacity and capabilities, symmetrical loading does not necessarily account for efficiencies and other considerations associated with the prime mover portion of the genset. For example, the prime mover, such as an internal combustion engine, may operate at a peak fuel efficiency, as determined by a torque-fuel curve, that may not correlate with the output of the genset being requested by the symmetric load sharing arrangement. Other considerations that may not be accounted for include emissions from the prime mover. To address considerations associated with the prime mover, another technique for allocating the real power demand among multiple gensets is asymmetric loading. An example of asymmetric loading or load sharing is described in U.S. Publication No. 2014/0152006 (“the '006 publication”) in which an efficiency database with fuel efficiency data is consulted when allocating real power demand among gensets. While asymmetric loading as described in the '006 publication may account for efficiency considerations associated with the prime mover, it may in turn alter the proportional balance of electrical output requirements among the plurality of gensets. The present disclosure is directed to addressing these considerations.

### SUMMARY

The disclosure describes, in one aspect, a method of operating a plurality of gensets in an asymmetric load sharing arrangement with respect to an electrical load. According to the method, a real power request associated with electrical load is received and used to calculate a calculated real power request per genset for each of the plurality of gensets. In accordance with asymmetrical loading strategies, the calculated real power requests per genset can be based on at least one of the real power request, fuel consumption considerations, and emission considerations associated with prime movers of the gensets. The method further calculates a calculated reactive power request per genset for each of the plurality of gensets based on the calculated real power request per genset and a rated power factor associated with each of the plurality of gensets. The method thereafter determines a total reactive power offset based on the calculated reactive power request per genset and an actual reactive power request from the electrical load. The total reactive power offset is allocated among the plurality of gensets to provide a reactive power offset per genset for each of the plurality of gensets. The method thereafter determines a final reactive power request per genset for the plurality of gensets based on the reactive power offset per genset and the calculated reactive power request per genset and operates the plurality of gensets in accordance with the respective final reactive power request per genset.

In another aspect, the disclosure describes an electrical power system including a first genset having a first rated power factor and a second genset having a second rated power factor. The first and second gensets are connected in a parallel arrangement to a common bus communicating with an electrical load. The electrical power system includes a multi-engine optimizer controller configured to optimize at least a first calculated real power request associated with the first genset and a second calculated real power request associated with the second genset. The first and second calculated real power requests can be based on a real power request from the electrical load and at least one of fuel consumption consideration, and emission considerations. To address reactive power components associated with the electrical load, the electrical power system also includes a reactive power controller in electrical communication with the multi-engine optimizer controller and with the first genset and the second genset. The reactive power controller can be configured to calculate a first calculated reactive power request based in part on the first rated power factor and a second calculated reactive power request based in part on the second rated power factor. Further, the reactive power controller can determine a total reactive power offset associated with at least both the first genset and the second genset. The reactive power controller then allocates the total reactive power offset to the first genset and the second genset to provide a first reactive power offset associated with the first genset and a second reactive power offset associated with the second genset.

In yet another aspect, the disclosure describes an electronic controller for controlling a plurality of gensets arranged in parallel in an asymmetrical load sharing arrangement. The electronic controller has executable instructions for optimizing a real power request for each of the plurality of gensets based upon efficiency and/or emissions considerations associated with a prime mover of a respective genset. In addition, the electronic controller has executable instructions for calculating a calculated reactive power request for each of the plurality of gensets based upon a rated power factor associated with a respective genset and executable instructions for determining a total reactive power offset for the plurality of gensets based on an actual reactive power request being made by an electrical load. The electronic controller can allocate the total reactive power offset among the plurality of gensets to provide a final reactive power request for each of the plurality of gensets. The electronic controller can also determine a final apparent power request for each of the plurality of gensets based on the final reactive power request for each of the plurality of gensets and the real power request for each of the plurality of gensets.

### BRIEF DESCRIPTION OF THE DRAWINGS

FIG. 1 is a schematic illustration of a marine vessel having a plurality of generator sets (gensets) to generate electrical power for the electrical requirements or load of the vessel, and various electronic controllers for regulating operation of the gensets.

FIG. 2 is a schematic representation of a control strategy implemented by the electronic controllers for regulating operation of the plurality of gensets that is configured to accommodate the real and reactive portions of the electrical load.

FIG. 3 is a flowchart embodying the control strategy and illustrating possible routines for regulating operation of the plurality of gensets.

### DETAILED DESCRIPTION

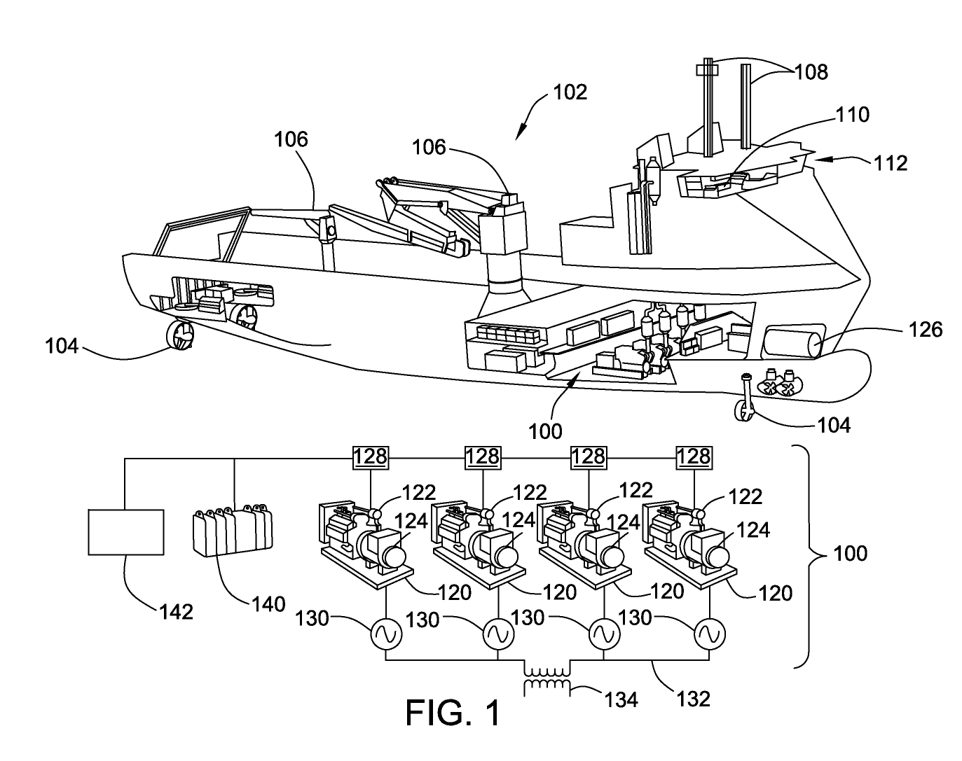

This disclosure relates to an electrical power system including a plurality of generator sets (gensets) for generating electrical power, specifically alternating current, and the control strategies and electronic or digital controllers for regulating operation of the gensets. Now referring to the drawings, wherein like reference numbers refer to like elements, there is illustrated in FIG. 1 an electrical power system 100 that may be arranged to generate electric power for an isolated electrical load such as, for example, the electrical requirements of a marine vessel 102 like a freighter or cargo ship as shown. In particular, the electrical power system 100 may generate electrical power for the propulsion units 104 of the marine vessel, which may be a plurality of azimuth thrusters. Azimuth thrusters are electrically driven units that can independently rotate with respect to the hull of the marine vessel, eliminating the need for a rudder. The azimuth thrusters are powered by electricity generated by the electrical power system 100 rather than being directly driven by a power unit such as an engine, reactor, or boiler. In addition to the propulsion units 104, the electrical requirements of the marine vessel may include motorized cranes 106 for lifting and moving freight, communication equipment 108 for communicating with shore and other marine vessels, and navigation controls 110 that may be disposed in the bridge 112 of the marine vessel for directing movement and operation of the marine vessel. These device make up the electrical load of the marine vessel.

As can be appreciated, the marine vessel 102 is electrically isolated from a larger power grid and therefore includes the independent electrical power system 100 to provide for its electrical power needs. The independent, “off-grid” electrical power system 100 may be referred to as an isolated system or an island. Other marine applications for the independent power system 100, in addition to the illustrated freighter, include military vessels, passenger liners, tankers, and the like. In addition to being utilized for marine vessels 102, the independent electrical power system 100 described herein may be utilized for oil or gas procuring applications, temporary military bases, or any other electrical application where electrical power from a utility-supplied power grid is not readily available or may be interrupted. Hence, a characteristic of the electrical power system 100 described herein is that it can operate independently of a larger electrical grid in which electrical power is supplied by other sources, such as power plants, nuclear reactors, hydro-electric dams, and the like.

To generate electrical power, the electrical power system 100 includes a plurality of generator sets 120, or gensets, which operate in cooperation with each other. In particular, each genset 120 includes a prime mover 122, such as an internal combustion engine and, in particular, a diesel compression ignition engine, and an electrical generator 124 or alternator coupled to the prime mover. The prime mover 122 can combust hydrocarbon fuel and air to produce a mechanical force or motive power that rotates a magnetic field in the electrical generator 124 that is converted to electrical power. To provide fuel for the prime mover 122 to combust, the electrical power system 100 may be operably associated with one or more fuel tanks 126 or reservoirs. In addition to the example of an internal combustion engine, other variations of prime movers 122 include gas combustion turbines, rotary engines, reactors, steam boilers, and the like. While the electrical capacity of the gensets 120 described herein may be rated at any suitable quantity, an exemplary genset may produce several kilowatts and the combination of the gensets may together produce several hundred kilowatts. To govern operation of the prime mover 122 and the electrical generators 124, each genset 120 may include an electronic genset controller 128 that may be a computing device capable of performing typical computing and digital processing functions.

The electrical power generated by the electrical generators 124 of the gensets 120 may be in the form of alternating current, or AC electricity, where voltage and the flow of current periodically changes direction, in contrast to direct current, or DC electricity. The phase change, or shift in direction of the alternating current, may produce current and voltage in accordance with a cycling waveform, in particular, a sinusoidal waveform in which the amplitude of the current and voltage periodically and repetitively changes from a positive value to an equal negative value and back to the positive value. Hence, each of the gensets 120 is shown as generating an alternating current waveform 130. To combine the electrical current being generated, the plurality of gensets 120 may be electrically connected to a common bus 132 or busbar in a parallel arrangement. In a parallel arrangement, the total current generated by the electrical power system 100 is the sum of the individual currents generated by each of the plurality of gensets 120 while the potential or voltage is generally the same across each of the gensets. The common bus 132 can be electrically connected through a network or circuit with the electrical equipment of the marine vessel 102, considered together to make up the electrical load 134 of the vessel. The plurality of gensets are therefore each responsible of providing a portion of the electrical load 134 of the vessel and together make up the power source of the vessel.

In a linear AC circuit, where the electrical load is purely resistive, the sinusoidal waveforms for the current and voltage may be in phase with each other so that their polarities change at the same instant and the product of the two values is always positive. The circuit is therefore considered as to deliver positive power to the electrical load. However, one aspect associated with generating electrical power in the form of alternating current is that the total power required may exceed the actual or real power being consumed by the electrical load. This may occur if the elements, components, or devices that physically comprise the electric circuit forming the electrical load include both purely resistive components, which are responsible for consuming and converting the electrical power into other forms of useful work, and reactive components that impart reactive effects with respect to the power. In particular, if reactive elements such as capacitive or inductive elements are included in the electrical circuit making up the electrical load 134, the reactive elements will cause the sinusoidal waveforms of the current and voltage to shift out of phase with each other adding additional resistance to the transfer of energy in the circuit. To overcome the additional resistance, the electrical power system must account for the reactive portion of the power demand required by the electrical load, referred to a reactive power, in addition to the real portion or real power that is converted into work. The combination of real power and reactive power may be referred to as apparent power, i.e., the total power dissipated by the electrical load.

Because the gensets 120 are connected in parallel, their electrical output including the real and reactive components must be regulated for synchronization purposes. To regulate and coordinate the plurality of gensets 120, one or more electronic controllers may communicate with each of the individual genset controllers 128 that direct operation of the individual gensets, which, in illustrated embodiment, may include a multi-engine optimizer (MEO) controller 140 and a reactive power controller 142, whose functions will be described in further detail herein. The electronic controllers may include a processor, an application specific integrated circuit (ASIC), or other appropriate circuitry for performing logic and digital functions, and may have associated memory or similar data storage capabilities. The electronic controllers may be discrete, individual units, or their functions may be distributed over a plurality of distinct components. Thus, the MEO controller 140 and the reactive power controller 142 may be implemented on the same computing equipment rather than as two distinct units as shown in FIG. 1. The electronic controllers may operate and communicate with each other using digital signals, analog signals, or through any other suitable means. The electronic controllers may communicate with each other through wired connections or may communicate wirelessly through radio frequency or wi-fi mediums.

As described above, one method for synchronizing the plurality of gensets 120 is symmetric load sharing in which each genset outputs a proportional share of the total electrical demand by the load. For example, if the total demand of the electrical load is 100 kilowatts, and the electrical power system 100 includes two equally rated gensets 120, each genset 120 may produce 50 kilowatts of power, or output one half of the electrical load. However, if the gensets are not equally rated, the symmetrical load sharing strategy determines which portion of the electrical load each genset must provide on a proportional or pro-rated basis. For example, if the first genset has a rated capacity of 100 kilowatts and the second has a rated capacity of 50 kilowatts, and the electrical load is 100 kilowatts, the symmetric load sharing method will direct the first genset to produce two-thirds of the load, or 66.6 kilowatts, and direct the second genset to produce one-third, or 33.3 kilowatts. Accordingly, symmetric load sharing ensures that each gensets is being operated at an equal proportional share of its rated electrical capacity and is subjected to the same level of stress and wear.

While symmetrical load sharing accounts evenly for the different electrical capacities of the plurality of gensets 120 of the electrical power system 100, it may not account for differences between the prime movers 122 of the individual gensets. For example, if the prime mover 122 is an internal combustion engine, each prime mover may operate in accordance with an associated torque-fuel curve that determines the motive force produced by the engine in relation to the fuel consumption of the engine. The torque-fuel curve may determine or indicate where the prime mover is operating most efficiently or according to its best fuel economy. The efficiency point of the prime mover 122 may not correspond to the electrical output being requested of a particular genset 120 by the symmetrical load sharing strategy. In other words, the portion of the electrical load being allocated to the gensets may cause the prime movers to operate inefficiently.

To account for the efficiency of the prime movers 122, the electrical power system 100 may be regulated according to an asymmetrical loading or load sharing method in which each genset 120 is operated on a basis other than being run to strictly output its proportional share of the electrical load 134. For example, the portion of the electrical load allocated to each genset may be based in part on the fuel efficiency of the prime mover. In addition to fuel efficiency considerations, the asymmetrical load sharing method may account for the emissions being produced by the prime mover through the fuel combustion process. To determine the portion of the electrical load 134 each of the individual gensets 120 is to supply, the electrical system 100 can process the efficiency considerations or similar considerations through the MEO controller 140.

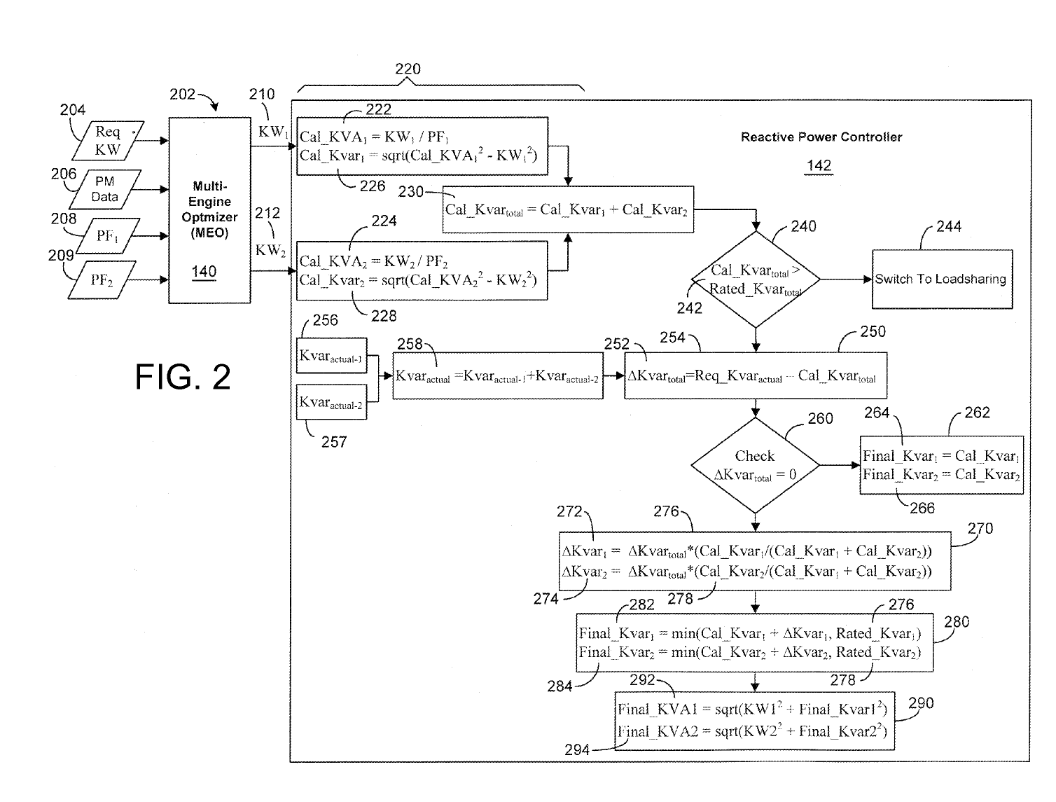

Referring to FIG. 2, there is illustrated a schematic representation of a possible control strategy 200 that may be implemented by the MEO controller 140 and the reactive power controller 142 operating in cooperation to perform the asymmetric load sharing method. The electrical power system associated with the method shown in FIG. 2 may, for example, include a first genset and a second genset, but in other embodiments may include any suitable number of gensets. The steps of the control strategy 200 described herein may be embodied as machine readable and executable software instructions, software code, or executable computer programs. The software instructions may be further embodied in one or more routines, subroutines, or modules and may utilize various auxiliary libraries and input/output functions to communicate with other equipment. The control strategy may also be associated with an operator interface through which the strategy may interact with an operator of the marine vessel.

In the first optimization step 202 carried out by the MEO controller 140, a real power request 204, which is the electrical demand on the electrical power system being made by the electrical load, measured in kilowatts, is input to the MEO controller. In addition to the real power request 204, information or data regarding fuel efficiency and/or emissions considerations, referred to as PM Data 206, that is associated with the prime movers is also received by the MEO controller 140. Other information regarding the prime movers, such as a first rated power factor PF₁ 208 associated with the first genset and a second rated power factor PF₂ 209 associated with the second genset is also input to the MEO controller 140. The rated power factor, or PF, is the rated ratio of real power to apparent power associated with an electrical device, such as the gensets, and thus accounts for the reactive power portion of the load. The power factor represents the capacity for actual work due to conversion of real power to work compared with the power lost due to the reactive effects incorporated in the circuit. Moreover, the rated power factors may be different for each of the gensets due to different design factors or capabilities.

The MEO controller 140 uses those values, and possibly other parameters, to calculate the portion of the electrical load that the first genset and the second genset will be responsible for supplying. In particular, the first optimization step 202 performed by the MEO controller 140 determines a first real power request 210 for the first genset and a second real power request 212 for the second genset. The first and second real power requests KW₁ 210, KW₂ 212 may be measured in watts or kilowatts (KW) and thus are represented in FIG. 2 as KW₁ for the first power request and KW₂ for the second power request. The values of the first real power request KW₁ 210 and the second real power request KW₂ 212 may add up to equal the total real power request 204 of the electrical load. Because the MEO controller 140 received and used the PM data 206 related to the prime movers as part of its calculations, the first real power request KW₁ 210 and the second real power request KW₂ 212 can be optimal or near optimal for operation of the prime movers associated with the respective first and second gensets. However, it should be appreciated that “optimized,” “optimal,” and the like are relative terms and should not be construed as an absolute or as addressing considerations other than as such considerations described herein.

Although the MEO controller 140 may determine the first and second real power requests, KW₁ and KW₂ 210, 212, that are within the rated capacities of the respective first and second gensets, it may not readily account for the reactive power component or imaginary power component of the electrical load 134. To account for the reactive power portion, the reactive power controller 142 further manipulates the first real power request, KW₁ 210, and the second real power request, KW₂ 212, to allocate the reactive power requirements across the plurality of gensets. In particular, the reactive power controller 142 performs a second calculation step 220 in which the apparent power that each genset is to produce is initially determined, where the apparent power is the combination of real and reactive power.

In the illustrated method, a first calculated apparent power request, Cal_KVA₁ 222, is calculated for the first genset based on the first real power request, KW₁ 210, and the first rated power factor 208. Likewise, a second calculated apparent power request, Cal_KVA₂ 224, is calculated for the second genset based on the second real power request, KW₂ 212, and the second rated power factor 209. Per convention, the apparent power may be quantified in volt-amperes (VA). To calculate the first and second calculated apparent power requests, Cal_KVA₁ 222 and Cal_KVA₂ 224, the reactive power controller 142 may use the following equations:

Cal_KVA₁=KW₁/PF₁ Eqn. 1:

Cal_KVA₂=KW₂/PF₂ Eqn. 2:

Thus, the calculated apparent power per genset is based in part on the rated power factors associated with each of the gensets. The rated power factors therefore becomes part of the methodology for allocating the electrical load among the plurality of gensets.

In addition to determining the first and second calculated apparent power requests, Cal_KVA₁ 222 and Cal_KVA₂ 224, the reactive power controller 142 in the second calculation step 220 can also determine the value of the reactive power portion that makes up the apparent power calculation. Per convention, the reactive power may be quantified in volts-amperes reactive, or var. For the illustrated embodiment, this includes determining a first calculated reactive power request, Cal_Kvar₁ 226, associated with the first genset and a second calculated reactive power request, Cal_Kvar₂ 228, associated with the second genset. To calculate the first and second calculated reactive power requests, the reactive power controller 142 may use the following equations:

Cal_Kvar₁=sqrt(Cal_KVA₁²−KW₁²) Eqn. 3:

Cal_Kvar₂=sqrt(Cal_KVA₂²−KW₂²) Eqn. 4:

Equations 3 and 4 calculate the reactive power portion for the individual gensets, and the total calculated reactive power request, Cal_Kvarₜₒₜₐₗ 230, associated with the electrical power system as a whole can be calculated by summing up the individual reactive power components according to the following equation:

Cal_Kvarₜₒₜₐₗ=Cal_Kvar₁+Cal_Kvar₂ Eqn. 5:

It can be appreciated that the first calculated reactive power request, Cal_Kvar₁ 226, the second calculated reactive power request, Cal_Kvar₂ 228, and the total calculated reactive power request, Cal_Kvarₜₒₜₐₗ 230, are theoretical in nature and are based in part on the rated power factor of the individual gensets. As described below, the control strategy may perform additional steps to ensure the theoretical calculations are in line with the actual demands of the electrical load.

In an embodiment, the reactive power controller 142 can check the total calculated reactive power request, Cal_Kvarₜₒₜₐₗ 230, against a reactive power rating for the electrical power system in a third check step 240 to ensure that the asymmetrical load sharing strategy complies with the ratings for the system. In the third check step 240, the total calculated reactive power request, Cal_Kvarₜₒₜₐₗ 230, is compared with the rated total reactive power limit, Rated_Kvarₜₒₜₐₗ 242, associated with the electrical power system including the plurality of gensets according to the following equation:

Cal_Kvarₜₒₜₐₗ >Rated_Kvarₜₒₜₐₗ Eqn. 6:

If the total calculated reactive power request, Cal_Kvarₜₒₜₐₗ 230, exceeds the rated total reactive power limit, Rated_Kvarₜₒₜₐₗ 242, the reactive power controller 142 can cease the asymmetric load sharing strategy and revert to the standard symmetric load sharing strategy 244 to avoid harming the electrical power system. If the rated total reactive power limit, Rated_Kvarₜₒₜₐₗ 242, is not exceeded, the reactive power controller 142 may continue with the asymmetrically loading of the plurality of gensets.

While the second calculation step 220 performed by the reactive power controller 142 calculates the theoretical reactive power requests to be allocated to the individual gensets, the reactive power controller can to align the calculated values with the actual demands being made by the electrical load. For example, the reactive power controller 142 can conduct a fourth determination step 250 to determine a total reactive power offset, ΔKvarₜₒₜₐₗ 252, representing the difference between the actual reactive power demand, Req_Kvar_{actual} 254, as measured from the electrical load, and the total calculated reactive power request, Cal_Kvarₜₒₜₐₗ 230. The total reactive power offset ΔKvarₜₒₜₐₗ 252 addresses any quantitative differences between the theoretical number obtained for the first calculated reactive power request, Cal_Kvar₁ 226, the second calculated reactive power request, Cal_Kvar₂ 228, and the electrical load. The total reactive power offset, ΔKvarₜₒₜₐₗ 252, can also be measured in volt-amps reactive and may be either a positive or a negative number. To determine the total reactive power offset, ΔKvarₜₒₜₐₗ 252, the reactive power controller 142 may use the following equation.

ΔKvarₜₒₜₐₗ=Kvar_{actual}−Cal_Kvarₜₒₜₐₗ Eqn. 7:

To determine Kvar_{actual}, the real power and the apparent power are measured at each genset of the plurality. The real and actual power can be used to determine an actual reactive power per genset, e.g., Kvar_{actual-1} 256, Kvar_{actual-2} 257, etc., for each genset of the plurality using, for example, equations 3 and 4. The total actual reactive power, Kvar_{actual} 258, for the plurality of gensets can be determined by summing the individual actual reactive powers as indicated.

The reactive power controller 142 can use the total reactive power offset, ΔKvarₜₒₜₐₗ 252, to determine a final reactive power request that can be allocated to each of the gensets to govern their output. For example, the reactive power controller 142 can perform a fifth check step 260 to check if the total reactive power offset, ΔKvarₜₒₜₐₗ 252, is zero, indicating there is no quantitative difference between the theoretical reactive components calculated by the reactive power controller 142 and the actual reactive portion demanded by the electrical load. The reactive power controller 142 may therefore in a set final reactive power request step 262 set the final reactive power request per genset, in particular, a first final reactive power request, Final_Kvar₁ 264, and a second final reactive power request, Final_Kvar₂ 266, equal to the respective first calculated reactive power requests, Cal_Kvar₁ 226, and second calculated reactive power request, Cal_Kvar₂ 228, according to the following equations:

Final_Kvar₁=Cal_Kvar₁ Eqn. 8:

Final_Kvar₂=Cal_Kvar₂ Eqn. 9:

If, however, the total reactive power offset, ΔKvarₜₒₜₐₗ 252, is a non-zero number, the reactive power controller 142 can perform additional steps to allocate the reactive power among the plurality of gensets. For instance, a sixth determination step 270 can be performed in which a first reactive power offset, ΔKvar₁ 272, associated with the first genset and a second reactive power offset, ΔKvar₂ 274, associated with the second genset are determined to allocate the total reactive power offset ΔKvarₜₒₜₐₗ 252 between the individual gensets. The sixth determination step 270 may utilize the first calculated reactive power request, Cal_Kvar₁ 226, and the second calculated reactive power request, Cal_Kvar₂ 228. The reactive power controller 142 may process these values according to the following equations:

ΔKvar₁=ΔKvarₜₒₜₐₗ*(Cal_Kvar₁/(Cal_Kvar₁+Cal_Kvar₂)) Eqn. 10:

ΔKvar₂=ΔKvarₜₒₜₐₗ*(Cal_Kvar₂/(Cal_Kvar₁+Cal_Kvar₂)) Eqn. 11:

After allocating the total reactive power offset, ΔKvarₜₒₜₐₗ 252, among the plurality of gensets, the reactive power controller 142 can perform a seventh setting step 280 in which a first final reactive power request, Final_Kvar₁ 282, and a second final reactive power request, Final_Kvar₂ 284, are calculated to accommodate the first reactive power offset, ΔKvar₁ 272, and the second reactive power offset, ΔKvar₂ 274. In particular, the seventh setting step 280 can set the first final reactive power request, Final_Kvar₁ 282, to the lower value of either first calculated reactive power request, Cal_Kvar₁ 226, plus the first reactive power offset, ΔKvar₁ 272, or to the first rated reactive power, Rated_Kvar₁ 276. Likewise, the second final react power request, Final_Kvar₂ 284, can be set to the lower value of the second calculated reactive power request, Cal_Kvar₂ 228, plus the second reactive power offset, ΔKvar₂ 274 or to the second rated reactive power, Rated_Kvar₂ 278. By considering the rated reactive power associated with the gensets, the seventh setting step 280 helps ensure electrical load does not overload the individual gensets. This can be done according to the following equations:

Final_Kvar1=min(Cal_Kvar₁+ΔKvar₁, Rated_Kvar₁) Eqn. 12:

Final_Kvar2=min(Cal_Kvar₂+ΔKvar₂, Rated_Kvar₂) Eqn. 13:

To determine the apparent power output each genset must produce to meet the real and reactive power demands of the electrical load, the reactive power controller 142 can perform an eighth determination step 290. The eighth determination step 290 computes a first final apparent power, Final_KVA₁ 292, and a second final apparent power, Final_KVA₂ 294, that will be output to the respective first and second gensets. The first and second final apparent power, Final_KVA₁ 292 and Final_KVA₂ 294, may account for both the real power component and reactive power component required by the system. To determine the first and second final apparent power, Final_KVA₁ 292 and Final_KVA₂ 294, the eighth determination step 290 may utilize the following equations:

Final_KVA1=sqrt(KW1²+Final_Kvar1²) Eqn. 14:

Final_KVA2=sqrt(KW2²+Final_Kvar2²) Eqn. 15:

Further, the total apparent power actually produced by the plurality of gensets can be readily determined by summing together the totality of the final apparent powers per genset.

### INDUSTRIAL APPLICABILITY

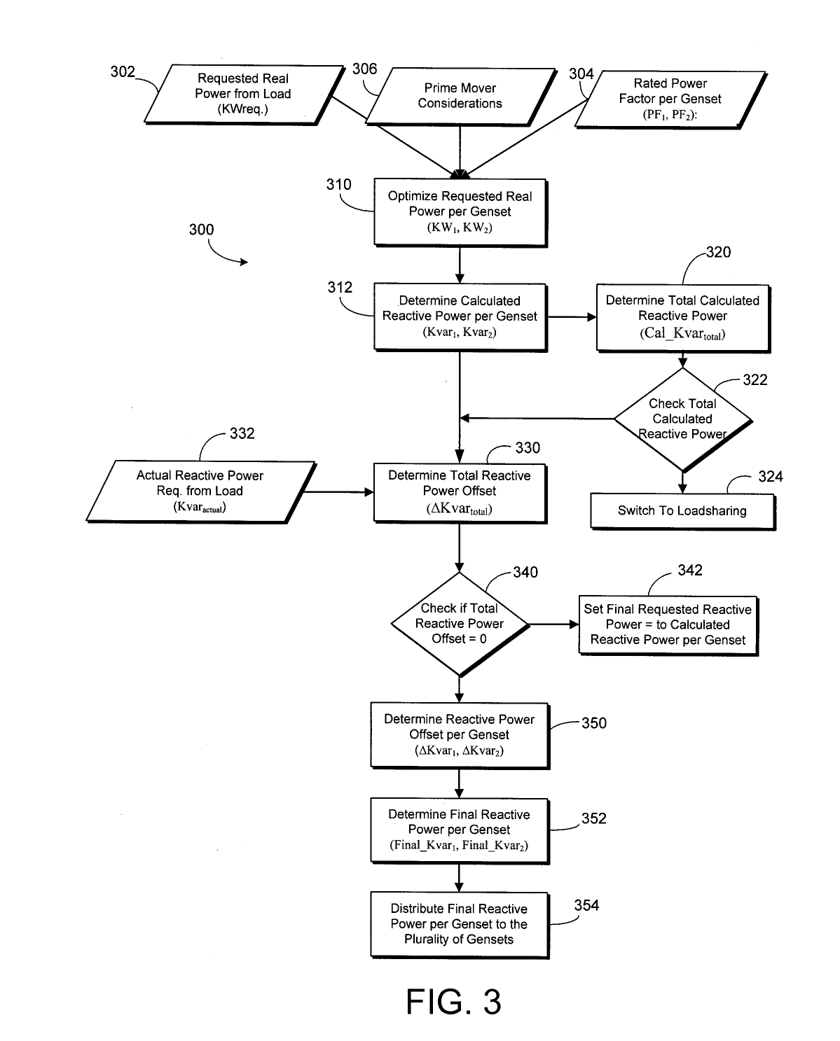

The present disclosure applicable to allocating electrical loads among a plurality of gensets that provide electrical power for an isolated load such as, for example, a marine vessel that when underway cannot be connected to a power distribution grid. The disclosure may also be applicable to applications with gensets operating in parallel to a utility-supplied grid that are run asymmetrically. Referring to FIG. 3, there is illustrated a flowchart implementing another embodiment of a control strategy 300 that embodies various aspects of the disclosure. The control strategy 300 is configured to supply the requested real power 302, measured in kilowatts for example, from the electrical load associated with the marine vessel or other application. To determine how to distribute the load among the plurality of gensets, the control strategy 300 can consider various information and data about each genset such as, for example, the rated power factor per genset 304. Other electrical information regarding the gensets may be considered according to the control strategy 300, such as rated capacity or electrical output limits and the like.

In addition to the electrical considerations and constraints on the gensets, the control strategy 300 may be configured to account for fuel efficiencies, emissions, and other considerations 306 associated with the prime mover portion of the gensets. In particular, this may be done through an asymmetric load sharing arrangement in which the considerations associated with the prime movers are addressed by a multi-engine optimizer controller that performs an optimization step that optimizes the requested real power 302 into values for the real power request per genset 310, which may also be in kilowatts. In addition to allocating the real power portion of the demand or load, the control strategy 300 may address the reactive or imaginary power portions that might arise from the inclusion of reactive elements or devices in the circuit that makes up the electrical load. To account for the reactive power components, the control strategy 300 may determine a calculated reactive power request per genset 312 based at least in part on the optimized real power request per genset 310 and the rated power factor per genset 304. The measured units for the calculated reactive power request per genset may be in volt-amperes reactive, or vars.

The control strategy 300 may include various checks to ensure that the asymmetric load sharing strategy has adequate capacity to meet the power demand or will otherwise avoid harming the electrical power system. To conduct an example of a check, the control strategy 300 may first sum each of the individual calculated reactive power requests per genset to determine the total calculated reactive power request 320 across the plurality of gensets. The total calculated reactive power request 320 can be checked in a decision step 322 against the rated power or capacity for the electrical power system as a whole. If the total calculated reactive power request 320 exceeds the system capacity, the control strategy 300 can cease the asymmetrical load sharing configuration and switch to symmetrical load sharing 324 which may satisfactorily address reactive power.

Because the calculated total calculated reactive power request 320 is a theoretical value, the control strategy 300 can include steps to bring the theoretical value closer to actuality. For example, the control strategy 300 can determine a total reactive power offset 330, which may be a positive or negative value and is based on the difference between the actual reactive power request from the load 332, which can be received as an additional data point, and a total calculated reactive power request 320. The total reactive power offset 330 should reflect any discrepancies regarding the reactive power quantities being calculated through the strategy with the actual demand by the system. Next, the control strategy 300 can determine a final reactive power request per genset that directs how to allocate the reactive power among the plurality of gensets. For example, if the total reactive power offset 330 is zero, which the control strategy 300 can determine through a total reactive power decision 340, that may mean the calculated reactive power requests per genset 312 is generally accurate. The control strategy 300 can set the final requested reactive power equal to the calculated request reactive power per genset in a setting step 342, which is communicated to the respective gensets to govern their operation.

However, if the total reactive power offset 330 has a non-zero value, the control strategy 300 can allocate that quantity among the plurality of gensets to ensure the reactive power is adequately addressed. In particular, the control strategy 300 determines a reactive power offset per genset 350 that may, for example, be based on the rated capacity of the individual gensets. The control strategy 300 then determines a final reactive power request per genset 352, which may be based upon the calculated reactive power request per genset 312 and the reactive power offset per genset 350. In other embodiments, the final reactive power request per genset 352 may also be based upon or take into consideration other characteristics of the genset, such as rated electrical capacity or the like. In a final distribution step 354, the control strategy can communicate the final reactive power per genset values to the respective gensets to direct their operation.

Hence, a possible advantage of the disclosure control strategy is enabling an isolated electrical power system to operate a plurality of gensets asymmetrically to address efficiencies or similar considerations related to the prime movers while also handling the reactive power components that may be developed in the electrical load. It is also believed that the disclosure enable operation of plurality of different gensets closer in accordance with the individual rated power factors and other rated capacities of the gensets. It should be noted that in addition to values and numbers explicitly described as being considered during the steps of the control strategy, other numbers and values may be considered as well.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of operating a plurality of gensets in an asymmetric load sharing arrangement with respect to an electrical load, the method comprising:
receiving a real power request from the electrical load;
optimizing a real power request per genset for each of the plurality of gensets based on at least one of the real power request, fuel consumption considerations, and emission considerations;
calculating a calculated reactive power request per genset for each of the plurality of gensets based on the real power request per genset and a rated power factor associated with each of the plurality of gensets;
determining a total reactive power offset based on the calculated reactive power request per genset and an actual reactive power request from the electrical load;
allocating the total reactive power offset among the plurality of gensets to provide a reactive power offset per genset for each of the plurality of gensets;
determining a final reactive power request per genset for the plurality of gensets based on the reactive power offset per genset and the calculated reactive power request per genset; and
operating each of the plurality of gensets in accordance with the respective final reactive power request per genset.

2. The method of claim 1, wherein the step of allocating the total reactive power offset to provide the reactive power offset per genset is based in part on the rated power factor associated with each of the plurality of gensets.

3. The method of claim 2, wherein the step of allocating the total reactive power offset to provide the reactive power offset per genset is based on a rated reactive power associated with each of the plurality of gensets.

4. The method of claim 3, further comprising determining a total calculated reactive power request by summing the calculated reactive power request per genset for the plurality of gensets.

5. The method of claim 1, further comprising comparing the total calculated reactive power request with a rated total reactive power limit associated with the plurality of gensets.

6. The method of claim 5, further comprising switching to a symmetrical load sharing arrangement in an event the total calculated reactive power request exceeds the rated total reactive power limit.

7. The method of claim 1, further comprising checking the total reactive power offset with zero.

8. The method of claim 7, further comprising setting the final reactive power request per genset to the respective calculated reactive power request per genset in an event the total reactive power offset equals zero.

9. The method of claim 1, wherein the electrical load is an isolated electrical load.

10. An electrical power distribution system comprising:
a first genset having a first rated power factor;
a second genset having a second rated power factor;
a common bus in electrical connection with the first genset and the second genset in a parallel arrangement, the common bus communicating with an electrical load;
a multi-engine optimizer controller configured to optimize at least a first real power request associated with the first genset and a second real power request associated with the second genset based on a real power request from the electrical load and at least one of fuel consumption consideration, and emission considerations;
a reactive power controller in electrical communication with the multi-engine optimizer controller and with the first genset and the second genset, the reactive power controller configured to:
calculate a first calculated reactive power request based in part on the first rated power factor and a second calculated reactive power request based in part on the second rated power factor;
determine a total reactive power offset associated with at least both the first genset and the second genset; and
allocate the total reactive power offset to at least the first genset and the second genset to provide a first reactive power offset associated with the first genset and a second reactive power offset associated with the second genset.

11. The electrical power distribution system of claim 10, wherein the reactive power controller is further configured to:
determine a first final apparent power associated with the first genset based on the first real power request and the first reactive power offset; and
determine a second final apparent power associated with the second genset based on the second real power request and the second reactive power offset.

12. The electrical power distribution system of claim 11, wherein the reactive power controller determines the total reactive power offset based on an actual reactive power request from the electrical load and by summing the first calculated reactive power request and the second calculated reactive power request.

13. The electrical power distribution system of claim 10, wherein the first genset and the second genset together have a rated total reactive power limit, and the reactive power controller is further configured compare the rated total reactive power limit with by summing the first calculated reactive power request and the second calculated reactive power request.

14. The electrical power distribution system of claim 13, wherein the reactive power controller is further configured to execute a symmetric load sharing arrangement to operate the first genset and the second genset if the rated total reactive power limit is exceeded.

15. The electrical power distribution system of claim 10, wherein the reactive power controller is further configured to check the total reactive power offset with zero.

16. The electrical power distribution system of claim 10, wherein the electrical load is an isolated electrical load.

17. An electronic controller operatively associated with a plurality of gensets arranged in parallel to operate in an asymmetrical load sharing arrangement, the electronic controller comprising:
executable instructions for optimizing a real power request for each of the plurality of gensets based upon efficiency and/or emissions considerations associated with a prime mover of a respective genset;
executable instructions for calculating a calculated reactive power request for each of the plurality of gensets based upon a rated power factor associated with a respective gensets;
executable instructions for determining a total reactive power offset for the plurality of gensets based on an actual reactive power request being made an electrical load;
executable instructions for allocating the total reactive power offset among the plurality of gensets to provide a final reactive power request for each of the plurality of gensets; and
executable instruction for determining a final apparent power request for each of the plurality of gensets based on the final reactive power request for each of the plurality of gensets and the real power request for each of the plurality of gensets.

18. The electronic controller of claim 17, further comprising executable instructions for comparing the total calculated reactive power request with a rated total reactive power limit for the plurality of gensets.

19. The electronic controller of claim 18, further comprising executable instructions for switching to operate the plurality of gensets in a symmetrical load sharing arrangement if the total calculated reactive power request exceeds the rated total reactive power limit.

20. The electronic controller of claim 17, further comprising executable instructions for calculating a calculated reactive power request for each of the plurality of gensets divides the real power request by a power factor associated with each of the plurality of gensets.
